(19) United States
(12) Patent Application Publication
(10) Pub. No.: US 2019/0016297 A1
(43) Pub. Date: Jan. 17, 2019

(54) IN-VEHICLE DEVICE CONTROL METHOD AND IN-VEHICLE CONTROL DEVICE

(71) Applicant: HITACHI AUTOMOTIVE SYSTEMS, LTD., Hitachinaka-shi, Ibaraki (JP)

(72) Inventor: Masashi SAITO, Hitachinaka-shi, Ibaraki (JP)

(73) Assignee: HITACHI AUTOMOTIVE SYSTEMS, LTD., Hitachinaka-shi, Ibaraki (JP)

(21) Appl. No.: 16/067,248

(22) PCT Filed: Nov. 14, 2016
(86) PCT No.: PCT/JP2016/083628

§ 371 Date: Jun. 29, 2018

(30) Foreign Application Priority Data
Jan. 12, 2016 (JP) 2016-003170

(51) Int. Cl. B60R 22/34; B60L 15/20; B60R 22/02; B60R 22/48; H02P 5/46

(52) U.S. Cl. CPC B60R 22/34; B60L 15/20; H02P 27/08; B60R 22/48; H02P 5/46; B60R 22/023

(57) ABSTRACT

The present invention provides an in-vehicle device control method and an in-vehicle control device capable of suppressing radiation noise occurring at the time of simultaneously driving a plurality of loads to activate a plurality of in-vehicle devices, respectively, without providing a noise suppression component newly. In a motor drive controller 25 that controls driving of two motors 27a and 27b for retractors to activate two retractors 26a and 26b for seat belts, respectively, when the two motors for the retractors are simultaneously driven, a phase difference δ is provided for two drive frequency waveforms 40a and 40b corresponding to the two motors.

### TECHNICAL FIELD

The present invention relates to an in-vehicle device control method and an in-vehicle control device.

### BACKGROUND ART

PTL 1 describes “a motor control device for a seat belt that includes a plurality of drive circuits, each of which has a motor to wind the seat belt and a drive unit to drive the motor, which are provided in parallel; a current measurement unit to measure a current flowing to each of the motors using a current detection unit common to the plurality of drive circuits; and a drive control unit to drive the plurality of drive circuits using a measurement result of the current measurement unit and a seat belt device including the same”.

### CITATION LIST

### Patent Literature

PTL 1: JP 2014-133484 A

### SUMMARY OF INVENTION

### Technical Problem

For example, in a motor control device 81 described in PTL 1, when a seat belt 11 for a driver seat is wound or drawn, switching elements T1 and T3 are turned on/off and a motor M1 is PWM-driven. On the other hand, when a seat belt 21 for a passenger seat is wound or drawn, switching elements T2 and T4 are turned on/off and a motor M2 is PWM-driven. Therefore, when the two seat belts 11 and 21 are wound or drawn at the same time, the two motors M1 and M2 are PWM-driven at the same time and radiation noise may increase.

The present invention has been made in view of the above problem and an object thereof is to provide an in-vehicle device control method and an in-vehicle control device capable of suppressing radiation noise occurring at the time of simultaneously driving a plurality of loads to activate a plurality of in-vehicle devices, respectively, without providing a noise suppression component newly.

### Solution to Problem

To solve the above problem, the present invention provides an in-vehicle control device for controlling driving of a plurality of loads to activate a plurality of in-vehicle devices, respectively. When the plurality of loads are simultaneously driven, characteristics of a plurality of drive signals corresponding to the plurality of loads are different from each other.

### Advantageous Effects of Invention

According to the present invention, it is possible to suppress radiation noise occurring at the time of simultaneously driving a plurality of loads to activate a plurality of in-vehicle devices, respectively, without providing a noise suppression component newly. Other objects, configurations, and effects will be more apparent from the following description of embodiments.

### BRIEF DESCRIPTION OF DRAWINGS

FIG. 1 is a diagram showing a collision safety device of a vehicle as an example of an in-vehicle control device according to the present invention.

FIG. 2 is a diagram showing a state in which an occupant who sits on a driver seat is restrained by a seat belt and a state in which an occupant who sits on a passenger seat is restrained by a seat belt.

FIG. 3 is a diagram showing a power system of a motor-driven vehicle as another example of the in-vehicle control device according to the present invention.

FIG. 4 is a time chart of a drive frequency by a conventional frequency spreading method.

FIG. 5 is a time chart of a drive frequency by a frequency spreading method according to a first embodiment of the present invention.

FIG. 6 is a time chart of a drive frequency by a frequency spreading method according to a second embodiment of the present invention.

FIG. 7 is a time chart of a drive frequency by a frequency spreading method according to a third embodiment of the present invention.

FIG. 8 is a time chart of a drive frequency by a frequency spreading method according to a fourth embodiment of the present invention.

FIG. 9 is a time chart of a drive frequency by a conventional frequency fixing method.

FIG. 10 is a time chart of a drive frequency by a frequency fixing method according to a fifth embodiment of the present invention.

FIG. 11 is a time chart of a motor ON/OFF signal by conventional PWM control.

FIG. 12 is a time chart of a motor ON/OFF signal according to a sixth embodiment of the present invention.

### DESCRIPTION OF EMBODIMENTS

Embodiments of the present invention will be described below using the drawings. In the drawings, the same members are denoted by the same reference numerals and duplicate explanation will be appropriately omitted.

### First Embodiment

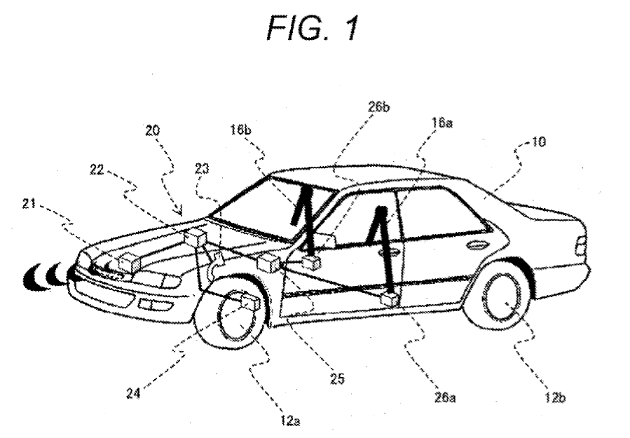

FIG. 1 is a diagram showing a collision safety device of a vehicle as an example of an in-vehicle control device according to the present invention.

A collision safety device 20 includes an obstacle sensor 21, a collision determination controller 22, a brake assist device 23, a wheel speed sensor 24, a motor drive controller 25, a retractor 26a for a driver seat side seat belt to wind and draw a driver seat side seat belt 16a, and a retractor 26b for a passenger seat side seat belt to wind and draw a passenger seat side seat belt 16b.

The obstacle sensor 21 is attached to a front portion of a vehicle 10 and outputs a signal according to a distance with an obstacle to the collision determination controller 22. The wheel speed sensor 24 is attached to the vicinity of a front wheel 12a and outputs a signal according to a speed of the vehicle 10 to the collision determination controller 22.

The collision determination controller 22 determines whether or not the vehicle 10 collides with the obstacle, on the basis of the signals from the obstacle sensor 21 and the wheel speed sensor 24. For example, when the distance with the obstacle obtained from the output signal of the obstacle sensor 21 is smaller than a predetermined value and the vehicle speed obtained from the output signal of the wheel speed sensor 24 is larger than a predetermined value, the collision determination controller 22 determines that the vehicle 10 collides with the obstacle and outputs command signals to the brake assist device 23 and the motor drive controller 25 before the vehicle 10 collides with the obstacle. Each of the brake assist device 23 and the motor drive controller 25 executes a predetermined operation, on the basis of the command signal from the collision determination controller 22.

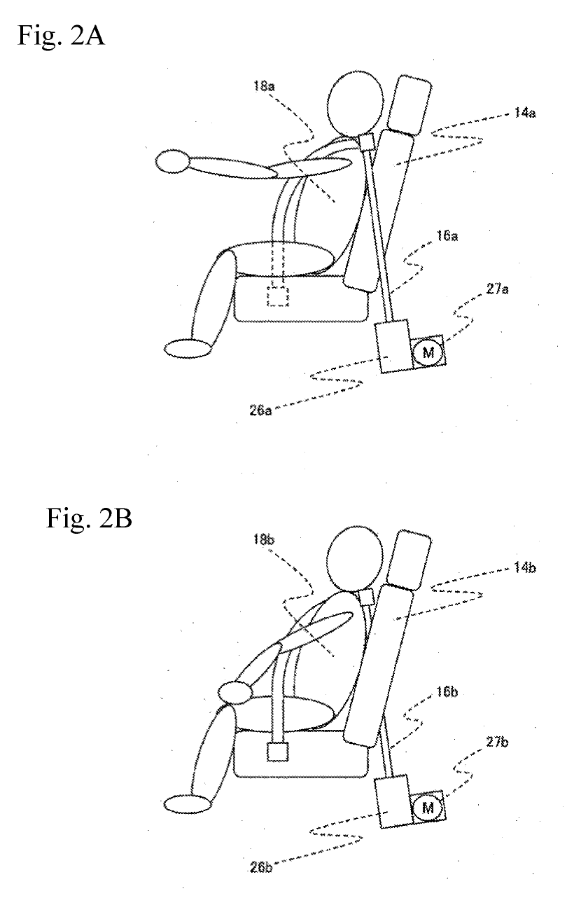

An operation of the collision safety device 20 will be described using FIG. 2. FIG. 2(A) is a diagram showing a state in which an occupant who sits on the driver seat is restrained by a seat belt and FIG. 2(B) is a diagram showing a state in which an occupant who sits on the passenger seat is restrained by a seat belt. In this embodiment, FIG. 2(A) is set as the driver seat side and FIG. 2(B) is set as the passenger seat side. However, the present invention is not limited thereto and FIG. 2(A) may be set as the passenger seat side and FIG. 2(B) may be set as the driver seat side.

The retractor 26a for the driver seat side seat belt has a motor 27a for a driver seat side retractor as a power source and drives the motor 27a for the driver seat side retractor, on the basis of the command signal from the motor drive controller 25, to wind or draw the driver seat side seat belt 16a. On the other hand, the retractor 26b for the passenger seat side seat belt has a motor 27b for a passenger seat side retractor as a power source and drives the motor 27b for the passenger seat side retractor, on the basis of the command signal from the motor drive controller 25, to wind or draw the passenger seat side seat belt 16b.

For example, the case where occupants 18a and 18b move slightly in a forward direction to generate gaps between the occupants 18a and 18b and seats 14a and 14b while the occupant 18a drives the vehicle 10 is considered. In the case where the vehicle 10 collides with the obstacle in this state, because the occupants 18a and 18b are not restrained by the seats 14a and 14b, the occupants 18a and 18b may strongly bump against the seats 14a and 14b due to a reaction of the collision. Therefore, the retractors 26a and 26b for the seat belts are activated such that the retractors drive the motors 27a and 27b for the retractors, on the basis of the command signals from the motor drive controller 25, and wind the seat belts 16a and 16b before the vehicle 10 and the obstacle collide with each other, thereby eliminating the gaps between the occupants 18a and 18b and the seats 14a and 14b. As a result, immediately before the vehicle 10 collides with the obstacle, the occupants 18a and 18b are restrained by the seats 14a and 14b, so that an impact on the occupants 18a and 18b can be alleviated.

Here, the motor 27a for the driver seat side retractor and the motor 27b for the passenger seat side retractor are simultaneously driven on the basis of the command signals from the collision determination controller 22. When the driver seat side occupant 18a and the passenger seat side occupant 18b simultaneously perform winding or retraction operations of the seat belts 16a and 16b at the time of getting on or off the vehicle, regardless of the presence or absence of the command signals from the collision determination controller 22, the motor 27a for the driver seat side retractor and the motor 27b for the passenger seat side retractor are simultaneously driven.

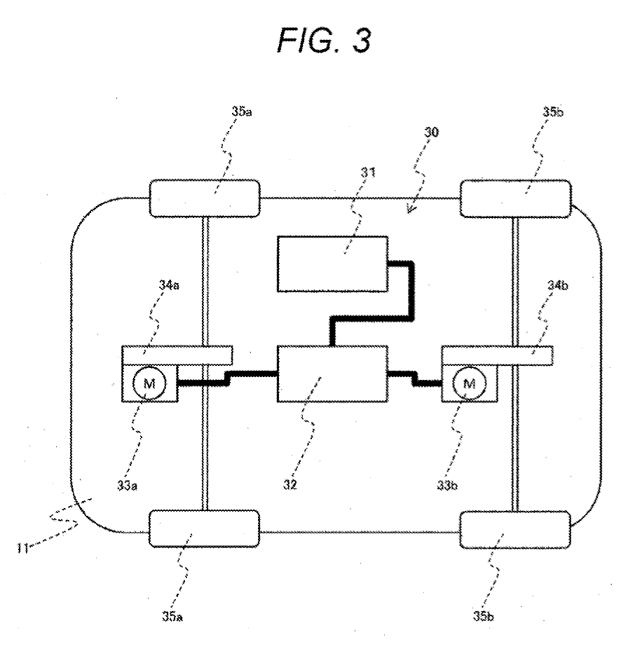

FIG. 3 is a diagram showing a power system of a motor-driven vehicle as another example of the in-vehicle control device according to the present invention.

A power system 30 of a motor-driven vehicle 11 includes a battery 31, an inverter system 32, a motor 33a for front wheels, a motor 33b for rear wheels, a speed reducer 34a for the front wheels, and a speed reducer 34b for the rear wheels.

Power for driving the motor is accumulated in the battery 31 and the power is supplied to the motor 33a for the front wheels and the motor 33b for the rear wheels via the inverter system 32. The motor 33a for the front wheels decreases its rotation speed via the speed reducer 34a for the front wheels, amplifies the rotation force, and drives front wheels 35a. On the other hand, the motor 33b for the rear wheels decreases its rotation speed via the speed reducer 34b for the rear wheels, amplifies the rotation force, and drives rear wheels 35b.

Here, although only one of the motor 33a for the front wheels and the motor 33b for the rear wheels (hereinafter, collectively referred to as the “motors for the wheels”) are driven during two-wheel drive (commonly called 2WD drive), the motor 33a for the front wheels and the motor 33b for the rear wheels are simultaneously driven during four-wheel drive (commonly called 4WD drive).

Next, drive signals of the two motors (the motors 27a and 27b for the retractors or the motors 33a and 33b for the wheels) used in the conventional in-vehicle control device (the collision safety device 20 of the vehicle 10 or the power system 30 of the motor-driven vehicle 11) will be described. In this embodiment, drive signals (hereinafter, referred to as “PWM drive signals”) based on general pulth width modulation (PWM) control as motor control will be described as an example.

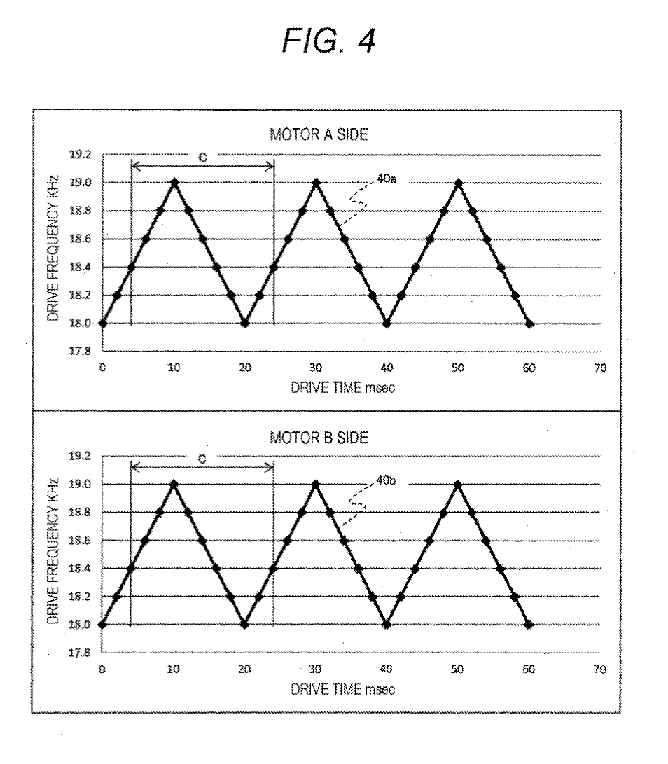

FIG. 4 is a time chart of frequencies (hereinafter, referred to as “drive frequencies”) of PWM drive signals by a conventional frequency spreading method. In FIG. 4, one of the two motors is referred to as a “motor A” and the other is referred to as a “motor B” and a horizontal axis shows drive time and a vertical axis shows a drive frequency.

As shown in FIG. 4, the drive frequencies corresponding to the motor A and the motor B change in the same manner in a range of 18 KHz to 19 KHz with time. It is known that a frequency band exceeding an audible frequency band is used as the drive frequency to avoid discomfort due to a high-frequency sound during load drive. In addition, the drive frequency is changed with time and conduction or radiation energy is avoided from being concentrated on a single frequency, so that a dispersion effect by frequency spreading is achieved.

However, when the two motors are driven at the same time by the PWM drive signals, the two drive frequencies are maintained in the same state, so that there is a problem in that noise in an AM band of the in-vehicle radio increases particularly.

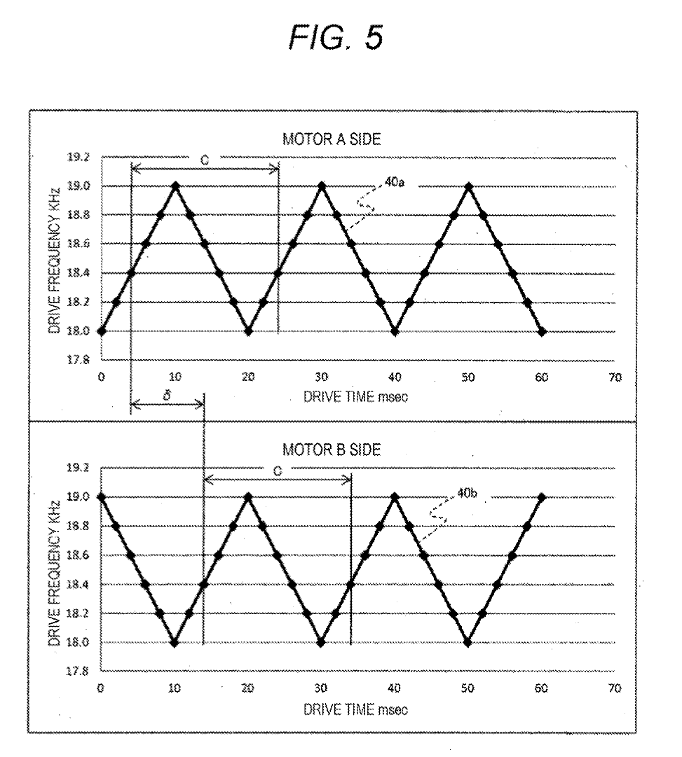

On the other hand, in this embodiment, as shown in FIG. 5, a phase difference δ (≠0) of a drive frequency waveform 40b of the motor B side is provided for a drive frequency waveform 40a of the motor A side.

According to this embodiment, similar to the related art (refer to FIG. 4), the drive frequencies of the two motors are changed with the time, so that conduction or radiation energy can be avoided from being concentrated on a single frequency. Cycles C of the two drive frequency waveforms 40a and 40b can be appropriately changed.

Furthermore, by providing the phase difference δ (≠0) in the two drive frequency waveforms 40a and 40b, the drive frequencies of the two motors are not maintained in the same state and peak frequencies of radiation noises occurring when the two motors are simultaneously driven are not matched with each other. Therefore, peak levels of the radiation noises can be suppressed. Here, when the two drive frequency waveforms 40a and 40b are generated by separate microcomputers (specifically, clocks), to constantly maintain the phase difference δ of the two drive frequency waveforms 40a and 40b, a circuit (synchronization circuit) for synchronizing the clocks is necessary and a configuration of a control circuit is complicated. On the other hand, when the two drive frequency waveforms 40a and 40b are generated by a single clock, the synchronization circuit is unnecessary, so that the control circuit can be simply configured.

### Second Embodiment

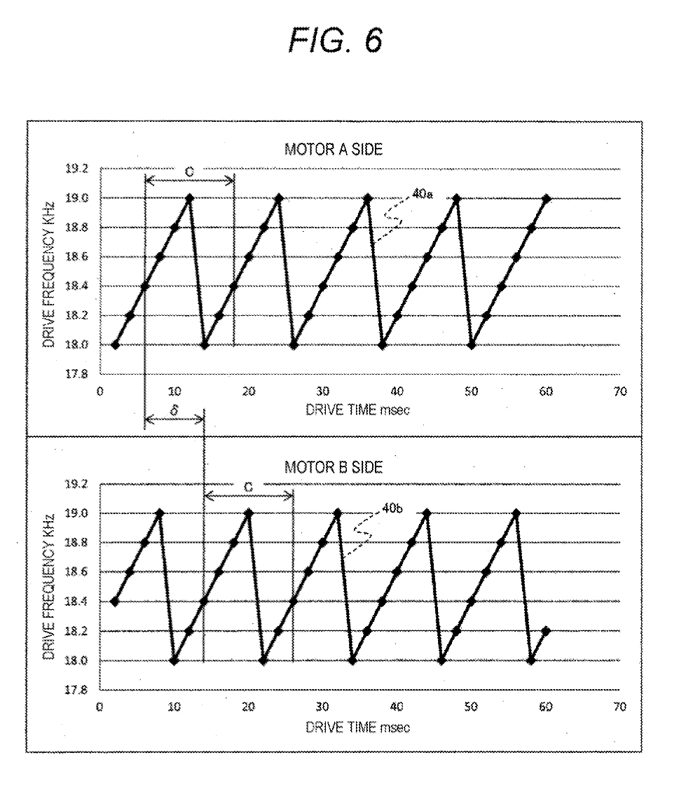

For a second embodiment of the present invention, a difference with the second embodiment will be mainly described. FIG. 6 is a time chart of a drive frequency by a frequency spreading method according to this embodiment.

In FIG. 6, a difference with the related art (refer to FIG. 5) is that waveform shapes of drive frequency waveforms 40a and 40b of two motors are changed from triangular wave shapes to sawtooth wave shapes.

Even in this embodiment, because drive frequencies of the two motors are not maintained in the same state, similar to the first embodiment, peak levels of radiation noises occurring when the two motors are simultaneously driven can be suppressed. The waveform shapes of the two drive frequency waveforms 40a and 40b can be appropriately changed.

### Third Embodiment

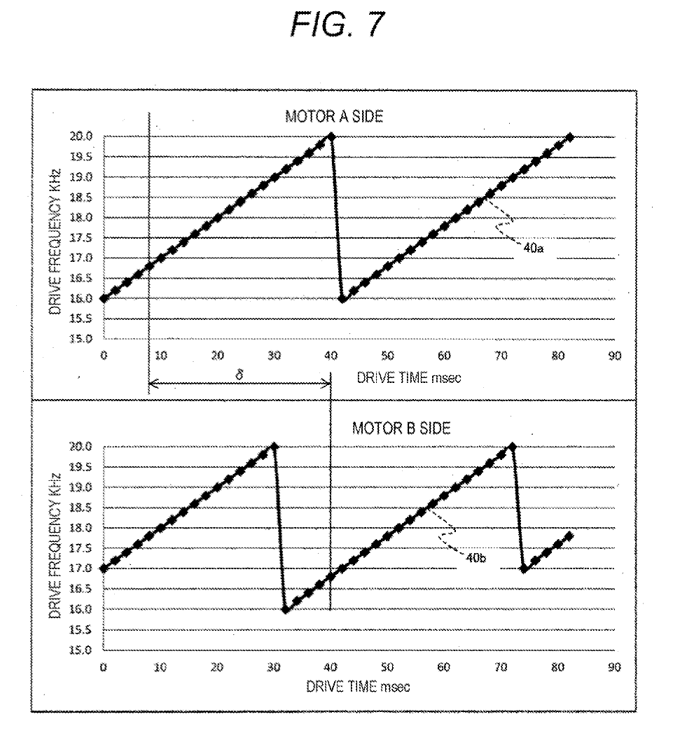

For a third embodiment of the present invention, a difference with the second embodiment will be mainly described. FIG. 7 is a time chart of a drive frequency by a frequency spreading method according to this embodiment.

In FIG. 7, the difference with the second embodiment (refer to FIG. 6) is that a variation range of drive frequencies of two motors is expanded from 18.0 KHz to 19.0 KHz (1.0 KHzp-p) to 16.0 KHz to 20.0 KHz (4.0 KHzp-p).

Even in this embodiment, similar to the first embodiment, peak levels of radiation noises occurring when the two motors are simultaneously driven can be suppressed.

Furthermore, the variation range of the drive frequencies of the two motors is expanded from 18 KHz to 19 KHz (1.0 KHzp-p) to 16 KHz to 20 KHz (4.0 KHzp-p), so that a frequency dispersion effect of the noise can be improved.

### Fourth Embodiment

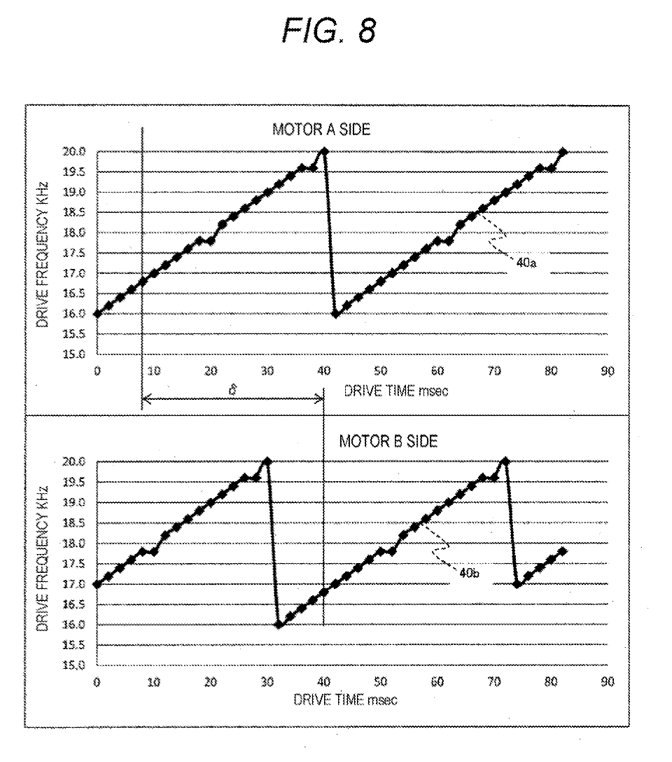

For a fourth embodiment of the present invention, a difference with the third embodiment will be mainly described. FIG. 8 is a time chart of a drive frequency by a frequency spreading method according to this embodiment.

In the third embodiment (refer to FIG. 7), a variation range of drive frequencies of two motors is expanded to 16.0 KHz to 20.0 KHz (4.0 KHzp-p), so that a frequency dispersion effect is improved. However, by expanding the variation range of the drive frequencies, frequencies (540 KHz and 594 KHz) obtained by multiplying 18.0 KHz and 19.8 KHz newly included in the variation range (16.0 KHz to 20.0 KHz) of the drive frequencies by 30 are matched with tuning frequencies (540 KHz and 594 KHz) of the in-vehicle radio, respectively. For this reason, an electromagnetic field generated when the drive frequency transits around 18.0 KHz or 19.8 KHz may become noise of the in-vehicle radio to affect the auditory sensation of a user.

On the other hand, in this embodiment, as shown in FIG. 8, the specific drive frequency (18.0 KHz or 19.8 KHz) of which the multiplied frequency is matched with the tuning frequency (540 KHz or 594 KHz) of the in-vehicle radio in the variation range (16.0 KHz to 20.0 KHz) of the drive frequencies is avoided from being used. In an example shown in FIG. 8, at timing when 18.0 KHz and 19.8 KHz are originally used, the frequency used at timing just before the timing is continuously used, so that 18.0 KHz and 19.8 KHz are avoided from being used. However, a method of avoiding the specific drive frequency is not limited thereto.

Even in this embodiment, the same effect as the third embodiment can be achieved.

Furthermore, the specific drive frequency of which the multiplied frequency is matched with the tuning frequency of the in-vehicle radio in the variation range of the two drive frequencies is avoided from being used. As a result, even when the variation range of the drive frequencies is expanded, it is possible to prevent occurrence of a situation where the electromagnetic field generated according to driving of the two motors becomes the noise of the in-vehicle radio to affect the auditory sensation of the user.

### Fifth Embodiment

For a fifth embodiment of the present invention, a difference with the related art will be mainly described. In the first to fourth embodiments, the example where the present invention is applied to control based on a frequency spreading method in which drive frequencies are changed with time has been described. However, in this embodiment, an example where the present invention is applied to control based on a frequency fixing method in which the drive frequencies are not changed will be described.

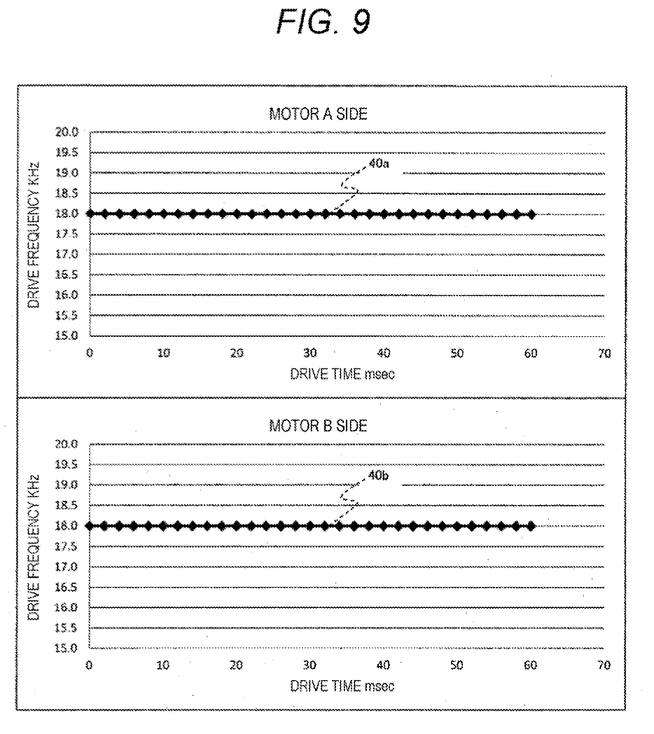

FIG. 9 is a time chart of a drive frequency by a conventional frequency fixing method and FIG. 10 is a time chart of a drive frequency by a frequency fixing method according to this embodiment.

In the conventional frequency fixing method, as shown in FIG. 9, a common frequency (18.0 KHz) is used as drive frequencies of a motor A and a motor B. Therefore, when the two motors are simultaneously driven, noise levels at the common drive frequency and a multiplied frequency thereof increase.

On the other hand, in this embodiment, as shown in FIG. 10, different frequencies (18.0 KHz and 16.0 KHz) are used as the drive frequencies of the motor A and the motor B, respectively. As a result, when the two motors are simultaneously driven, it is possible to suppress noise levels at the respective drive frequencies and the respective multiplied frequencies.

### Sixth Embodiment

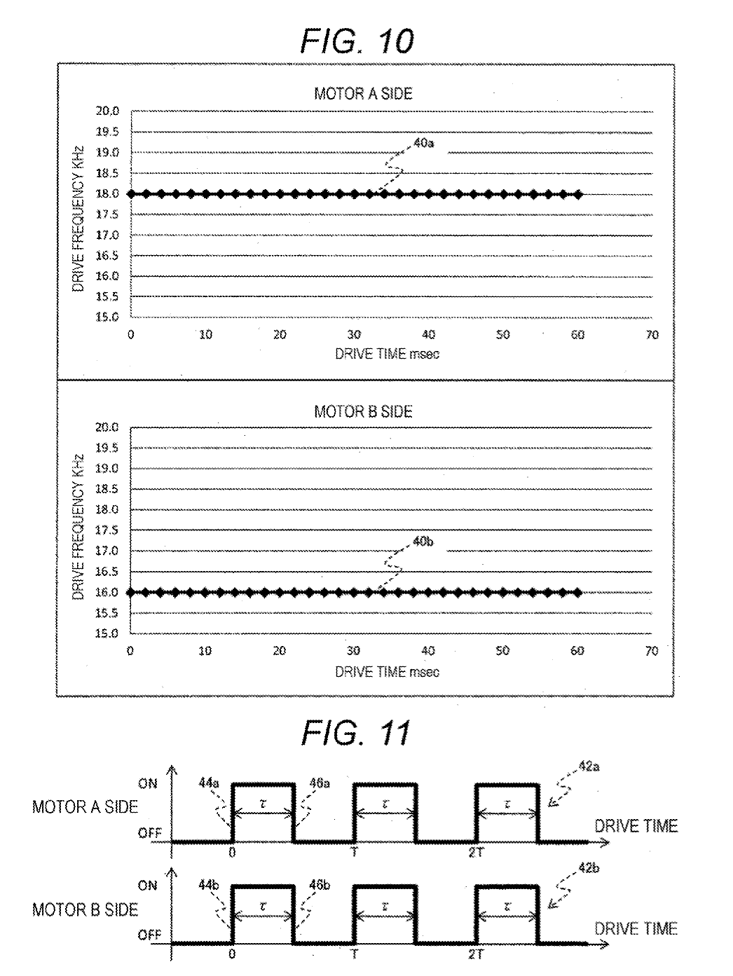

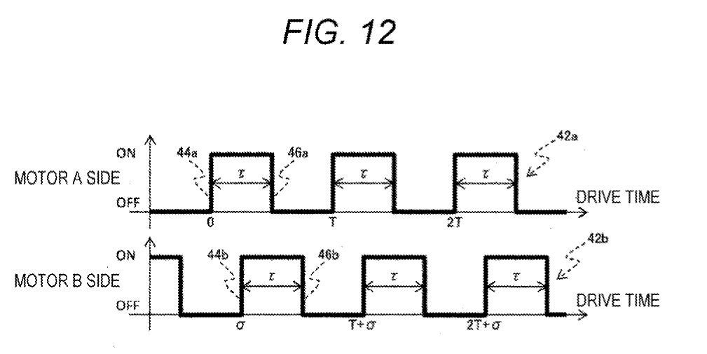

For a sixth embodiment of the present invention, a difference with the related art will be mainly described. FIG. 11 is a time chart of a motor ON/OFF signal (PWM drive signal) by conventional PWM control and FIG. 12 is a time chart of a motor ON/OFF signal according to this embodiment.

In the conventional PWM control, as shown in FIG. 11, power supply amounts to two motors are controlled by a duty ratio (=pulse width τ/cycle T). Here, cycles T of two ON/OFF signal waveforms 42a and 42b are equal to each other and a phase difference is zero. For this reason, when the two motors are simultaneously driven, timing of rising (transition from a non-energization state (OFF) to an energization state (ON)) 44a of the ON/OFF signal waveform 42a of the motor A side and timing of rising 44b of the ON/OFF signal waveform 42b of the motor B side are matched with each other. Furthermore, when the motor A and the motor B are simultaneously driven, pulse widths τ of the two ON/OFF signal waveforms 42a and 42b are matched with each other. For this reason, timing of falling (transition from the energization state (ON) to the non-energization state (OFF)) 46a of the ON/OFF signal waveform 42a of the motor A side and timing of falling 46b of the ON/OFF signal waveform 42b of the motor B side are matched with each other. As a result, there is concern that spike noises generated at the timings of the rising 44a and 44b and the falling 46a and 46b of the ON/OFF signal waveforms 42a and 42b increase.

On the other hand, in this embodiment, as shown in FIG. 12, the phase difference σ is provided for the two ON/OFF signal waveforms 42a and 42b. Thereby, the timings of the rising 44b and the falling 46b of the ON/OFF signal waveform 42b of the motor B side can be shifted with respect to the timings of the rising 44a and the falling 46a of the ON/OFF signal waveform 42a of the motor A side. As a result, when the two motors are simultaneously driven, the spike noises occurring at the timings of the rising 44a and 44b and the falling 46a and 46b of the ON/OFF signal waveforms 42a and 42b can be leveled and peak levels of radiation noises can be suppressed.

Although the embodiments of the present invention are described in detail, the present invention is not limited to the embodiments described above and various modifications are included. For example, in the embodiments, the example where the present invention is applied to the collision safety device of the vehicle or the power system of the motor-driven vehicle has been shown. However, an application target of the present invention is not limited thereto and the present invention can be applied to a motor for seat position adjustment, a door mirror, a position adjustment motor for a headlight, an electromagnetic control type clutch for suppressing slippage of front and rear and left and right tires, and an in-vehicle control device for driving an electric control type suspension by PWM control. In addition, in the embodiment, the example where the two motors are simultaneously driven has been shown. However, the application target of the present invention is not limited thereto and the present invention can also be applied to the case where three or more motors are simultaneously driven.

The embodiments are described in detail to facilitate the description of the present invention and the present invention is not limited to including all of the described configurations. In addition, a part of the configurations of the other embodiments can be added to the configurations of the certain embodiment and a part of the configurations of the certain embodiment can be removed or can be replaced by a part of the other embodiments.

### REFERENCE SIGNS LIST

10 vehicle

11 motor-driven vehicle

12a front wheel

12b rear wheel

14a, 14b seat

16a, 16b seat belt

18a, 18b occupant

20 collision safety device (in-vehicle control device)

21 obstacle sensor

22 collision determination controller

23 brake assist device

24 wheel speed sensor

25 motor drive controller

26a, 26b retractor for seat belt (in-vehicle device)

27a, 27b motor for retractor (load)

30 power system (in-vehicle control device)

31 battery

32 inverter system

33a, 33b motor for wheel (load)

34a, 34b speed reducer (in-vehicle device)

35a front wheel

35b rear wheel

40a, 40b drive frequency waveform

42a, 42b ON/OFF signal waveform

44a, 44b rising

46a, 46b falling

1. An in-vehicle control device for controlling driving of a plurality of loads to activate a plurality of in-vehicle devices, respectively, wherein,
when the plurality of loads are simultaneously driven, characteristics of a plurality of drive signals corresponding to the plurality of loads are different from each other.

2. The in-vehicle control device according to claim 1, wherein
frequencies of the plurality of drive signals are different from each other.

3. The in-vehicle control device according to claim 2, wherein
the frequencies of the plurality of drive signals are changed with time.

4. The in-vehicle control device according to claim 3, wherein
phases of frequency waveforms of the plurality of drive signals are different from each other.

5. The in-vehicle control device according to claim 2, wherein
frequencies of which multiplied frequencies are not matched with tuning frequencies of an in-vehicle radio are used as the frequencies of the plurality of drive signals.

6. The in-vehicle control device according to claim 2, wherein
the frequencies of the plurality of drive signals are generated by a common clock.

7. The in-vehicle control device according to claim 1, wherein
the plurality of in-vehicle devices include a retractor for a driver seat side seat belt and a retractor for a passenger seat side seat belt, and
the plurality of loads include a motor for a driver seat side retractor to activate the retractor for the driver seat side seat belt and a motor for a passenger seat side retractor to activate the retractor for the passenger seat side seat belt.

8. The in-vehicle control device according to claim 1, wherein
the plurality of in-vehicle devices include a speed reducer for front wheels and a speed reducer for rear wheels, and
the plurality of loads include a motor for the front wheels to activate the speed reducer for the front wheels and a motor for the rear wheels to activate the speed reducer for the rear wheels.

9. An in-vehicle device control method used at the time of controlling driving of a plurality of loads to activate a plurality of in-vehicle devices, respectively, wherein,
when the plurality of loads are simultaneously driven, characteristics of a plurality of drive signals corresponding to the plurality of loads are different from each other.

10. The in-vehicle device control method according to claim 9, wherein
frequencies of the plurality of drive signals are different from each other.

11. The in-vehicle device control method according to claim 10, wherein
the frequencies of the plurality of drive signals are changed with time.

12. The in-vehicle device control method according to claim 11, wherein
phases of frequency waveforms of the plurality of drive signals are different from each other.

13. The in-vehicle device control method according to claim 10, wherein
frequencies of which multiplied frequencies are not matched with tuning frequencies of an in-vehicle radio are used as the frequencies of the plurality of drive signals.

14. The in-vehicle device control method according to claim 10, wherein
the frequencies of the plurality of drive signals are generated by a common clock.

15. The in-vehicle device control method according to claim 9, wherein
the plurality of in-vehicle devices include a retractor for a driver seat side seat belt and a retractor for a passenger seat side seat belt, and
the plurality of loads include a motor for a driver seat side retractor to activate the retractor for the driver seat side seat belt and a motor for a passenger seat side retractor to activate the retractor for the passenger seat side seat belt.

16. The in-vehicle device control method according to claim 9, wherein
the plurality of in-vehicle devices include a speed reducer for front wheels and a speed reducer for rear wheels, and
the plurality of loads include a motor for the front wheels to activate the speed reducer for the front wheels and a motor for the rear wheels to activate the speed reducer for the rear wheels.
